(19) United States
(12) Patent Application Publication
(10) Pub. No.: US 2013/0009059 A1
(43) Pub. Date: Jan. 10, 2013

(54) DEVICE FOR INCREASED EYE PROTECTION

(76) Inventor: Nunzio Giuseppe Caruso, Neuhausen (CH)

(21) Appl. No.: 12/532,691

(22) PCT Filed: Mar. 18, 2008
(86) PCT No.: PCT/CH2008/000117

§ 371 Date: Sep. 23, 2009

(30) Foreign Application Priority Data
Mar. 26, 2007 (CH) 485/07

(51) Int. Cl. G02C 7/10; G01J 1/44; G02F 1/1335

(52) U.S. Cl. 250/338.1; 351/44; 349/14; 250/214 AL; 351/159.65

(57) ABSTRACT

Device with at least one filter, in particular for a relieving and preventive eye protection as glasses, sun glasses or pane, wherein the device comprises at least one filter for influencing and filtering UV, blue light and infrared radiation, wherein the at least one filter is characterized by specific limit values defined in their combination.

A large number of devices for increased eye protection are known from the prior art, such as for example sunglasses or tinted glass panes. All these devices have the disadvantage that they do not offer optimal protection against sunlight and other, non visible types of electromagnetic radiation.

The problem addressed by the present invention therefore is to create a device that is more advantageous to the human eye. This problem is solved with a device for increased eye protection having the features of claim 1. The dependent claims 2 to 23 relate to further, advantageously designed devices.

The invention is described in the following with the aid of drawings.

The device according to the invention is later clarified in detail using various exemplary embodiments.

### BRIEF DESCRIPTION OF THE DRAWINGS

The drawings used to explain the exemplary embodiments show:

FIG. 1 a nose bridge support in different sizes;

FIG. 2 a further nose bridge support with flexible materials;

FIG. 3 a further, adjustable, nose bridge support

FIG. 4 the increased coverage of the transmission spectrum of a first exemplary embodiment of a filter of a pair of sunglasses;

FIG. 5 the increased coverage of the transmission spectrum of a second exemplary embodiment of a filter of a pair of sunglasses;

FIG. 6 the increased coverage of the transmission spectrum of a third exemplary embodiment of a filter of a pair of sunglasses;

FIG. 7 a front view of a pair of sunglasses with expanded side protection above, below and to the side;

FIG. 8 a side view of a pair of sunglasses;

FIG. 9 a detail view of a pair of sunglasses;

FIG. 10 a plan view from above of a pair of sunglasses;

FIG. 11 the construction of a filter;

FIG. 12 a plan view from above of a further embodiment of a pair of sunglasses;

FIG. 13 A plan view of the earpieces of the sunglasses.

In order to obtain increased eye protection that better protects against UVC, UVB, UVA, blue light+infrared rays, we have developed sunglasses and glasses for all possible fields of application. The standard has little to say about shape and even less about side protection.

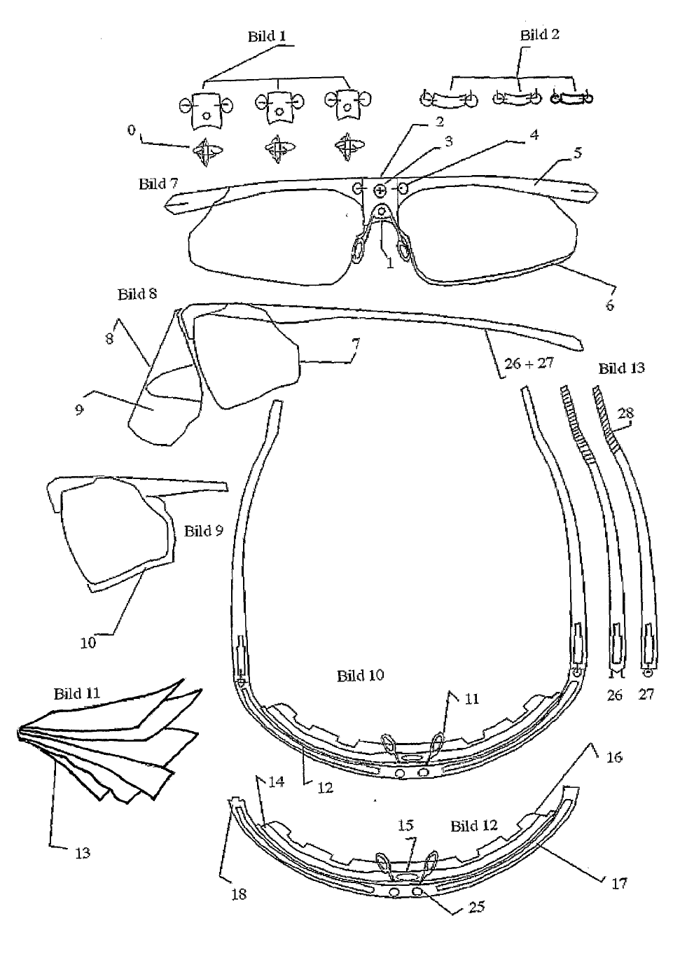

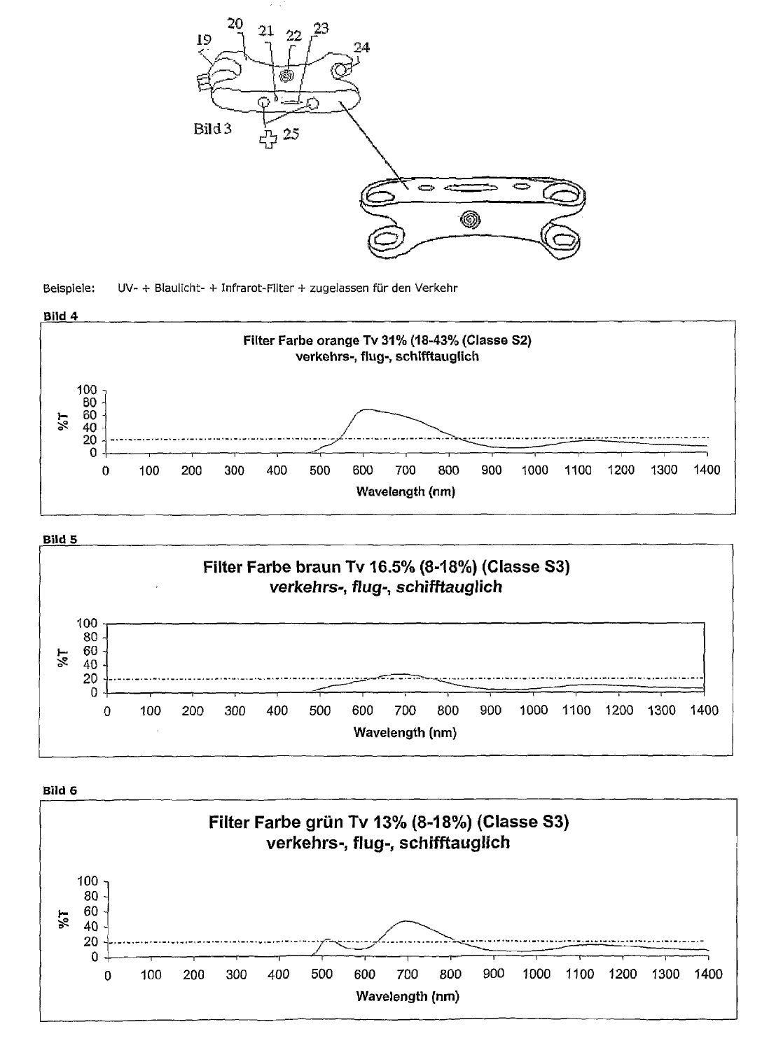

Each facial shape is structured differently and for better protection each requires an adjustable pair of sunglasses or glasses. For this reason there are many sunglasses in existence today that offer no increased side protection. We have carefully studied the anatomy of the faces of Africans, Arabs, Asians, Europeans, Indians, Latinos (Central and South America) etc., and come to the conclusion that we can adjust our sunglasses or glasses and even replace certain parts, and can therefore adapt them optimally and better to the shape of the face. In doing so we optimize the side protection all around the face and reduce the gaps. When referring to electromagnetic rays, we do not speak in terms of mm but rather nm. The core of the idea is the central part of the frame that we use as a nose support part=bridge, with or without joints (FIGS. 1-3) for the sunglasses or glasses. This is not the conventional nose piece, but rather the main frame, where we fix different sizes of nose support parts on to the nose piece=nose part (FIG. 1-3)=nose pads (FIG. 7 no. 1)=nose shells (FIG. 7 no. 1). In addition, all our sunglasses and glasses follow the shape of the head, by which means we ensure an optimal and better side protection. In order to better facilitate this, we require these important nose support parts. In addition, nose protection can also be fitted and fixed in place. This part then protects the entire nose against the dangerous UV rays and other influences. This part can be made out of plastic, leather, breathable material or any desired material, and the nose piece or the nose support part or frame can be equipped with photovoltaic cells. Also, measurement probes can be fitted to measure the UV radiation and to transmit the data. We offer an autonomous power supply that can be achieved by solar power on the glasses, with solar panels, and can be supplied using batteries or rechargeable batteries.

The second important element that effects increased eye protection is the filters. Through many years of intensive studies we have developed special filters, which absorb not only UVC, UVB and UVA, but also go beyond the EN 1836, CEN and ISO standards to additionally cover the blue light and the infrared spectrum, from FIGS. 4-6. In addition our filters meet the colour recognition standard taking into account colours such as red, yellow, blue and green as well as the transmittance Tv, and are therefore qualified for use in traffic, on ships and for flights. According to our research there are currently no filters that possess and offer all these characteristics together. This is one reason why we are having these filters patented. These technologies can be integrated in different combinations for example into vehicles of all types, cars, trucks, delivery vans, visors, aeroplanes, helicopters, ultra light and light aeroplane cockpits and windows, window panes and window facades, ships, boats and buildings, doors, windows or in many other conceivable applications where UVC, UVB, UVA, blue light are to be blocked (FIGS. 4-6), which are evident in patent claim 1. This applies to all possible areas where these filter types are required and need to be used and would want to be used.

Moreover, an extendable anti-misting system is important. For high performance sports or types of work where increased sweating occurs, we have developed a special anti-mist technique that is extendable. The anti-mist coating is fixed on the filters and cannot be washed off. In order to achieve the extension, we add our special fluid. This ensures the optimal distribution of the otherwise oversaturated anti-mist filter. Without this additive, the anti-mist system would reach its limits in a few minutes. We analyzed and tested various anti-misting systems worldwide, and came to the conclusion that there are no sunglasses, glasses or similar product in use today that can achieve our properties in this closed area. In order to be able to make a true comparison, we must take sunglasses, ski goggles, masks or glasses that are equally closed and in which the air volumes are similar. On both the outside and the inside of the filter, we would like to create a lotus effect. Undesirable additional effects should not adhere to the filter or frame. We have in mind here dust, dirt, grease deposits, oil etc.

LCD technologies (LCD=liquid crystal display) can be integrated into the design according to the invention. LCD technologies work together with our filters or we incorporate an additional part for glasses carriers. The liquid crystal technologies are further proper elements where our products differ from conventional sunglasses, glasses and other materials that offer the same eye protection. These LCD technologies promise much for our sunglasses, all other types of glasses and conceivable materials. Using them we can create important added value and provide increased eye support. The LCD technologies then assume the phototropic properties, polarisation as well as dioptre adaptations and date information that can be reproduced in visual and acoustic form via the LCD as well as headphones. This technology can be applied in different layers, either individually or together. It is important that the technologies named above are brought together and therefore emerge into new high-quality, unique products. The LCD technologies are of little benefit if the increased protection and the construction of the sunglasses are absent without the side protection described. The LCD can be operated with solar energy, rechargeable batteries or external power sources. The LCD can be supplied with the power directly on the glass, the sunglasses and glasses frame externally, the nose support piece (FIG. 3), nose holder. This technology in this combination with the protective filters against UVC, UVB, UVA, blue light and IR=infrared can also be used in eyepieces, windows, cockpits in aeroplanes, ships, windows of vehicles, cars, trucks, delivery vans, windows, window facades etc. supplied by us in different combinations. The filters assume the same protection functions against UVC, UVB, UVA, blue light and IR=infrared.

Disadvantages of well known devices for increased eye protection. Today many sunglasses and glasses provide insufficient protection or even produce counterproductive effects. As an example, sunglasses or glasses with corrective glazing could be mentioned, which can be used simultaneously as sunglasses and which darken according to the brightness. Due to the darkening of the filter, the pupil opens and the diffuse UV rays reach the interior of the lens and the eye in increased amounts. We therefore circumvent our own protection that works with brightness and darkness. Corrective glasses with a bend of more than 22° suffer from distortions. Side protection is therefor not possible with glass. Some manufacturers try to cover up this uncovered part with leather or plastic. The disadvantage is that the viewing angle is very much reduced. This therefore promotes an increased risk of accident.

At present, the different facial shapes are not considered. This is detrimental to increased and improved eye protection, which can be improved by good side protection. This is caused by diffuse light radiation. Also, pollen and dust affect the eye more so that inflammation and injuries can result.

There are very few compact, very lightweight, sunglasses, ski goggles, paragliding, hang-gliding or surfing glasses etc. These require large amounts of space and weight.

The standards EN 1836, CEN or ISO today only demand a level of protection up to 380 nm but compliance with them can be claimed as 100% UV protection. Ophthalmological and scientific studies have shown that in certain areas, such as for pilots, outdoor areas, and persons who are outdoors for more than two hours require increased eye protection and protective filters against UVC, UVB, UVA, blue light and infrared as described in patent claim 1, and these are therefore in addition suitable for use in traffic, on ships and for flights. The harmful radiation levels can be measured in Watt/cm² or Joule/cm². There are filters in existence today that are in category 4 and cover the spectrum of UVC, UVB, UVA and blue light. These are too dark and therefore not suitable for use in traffic. Additionally, in mountain areas when there is a change in the weather from strong sunshine to cloudy or storm conditions, the sunglasses, ski goggles or glasses in category 4 (see standard EN 1836) no longer provide sufficient visibility. Therefore it is important for us that we cover the extended spectrum of UVC, UVB, UVA, blue light and infrared combined, and achieve this even in category 2 and category 3. In addition to this, we have developed various filter colours and colour recognition has been taken into account.

At present, such technological filters, with the values and properties achieved by us, as described in patent claim 1 and therefore providing protection against UVC, UVB, UVA, blue light and IR including colour recognition in accordance with international standards; and yet additionally suitable for use in traffic, on ships and for flights in Cat. 2 or Cat. 3 are not to be found. Some materials existing today offer a blue light filter, but are not fully approved for use in traffic. These include the blue light or cut-off filters. The yellow dye reduces the blue light but increases the infrared range. The yellow dye can only reduce the blue light, but not the infrared radiation. The yellow dye increases the transmission of the infrared range and allows more than about 45-50%, or in the case of yellow and orange filters even more than 70%-80%, of the infrared radiation through. The current state of the art includes UV+blue light filters with increased infrared radiation. Some of the materials used here are for example optically transparent polymeric organic materials produced from polycarbonates such as poly 4,4-dioxydi-phenyl-2,2-propane, sold under the brand name LEXAN, polymethylemthacrylates sold under the brand name Plexiglas, copolymers of polyol arylcarbonates sold under the name CR-39, especially diethyleneglycol bis acryl carbonates polycarbonate, polyester, cellulose propionate, cellulose acetate, acryl carbonates and copolymers, diethylene glycol bis aryl carbonates, vinyl acetates, cellulose propionates, cellulose butyrates, polystyrenes and methylemethacrylates, vinyl acetates and acrylonitriles and the copolymers and cellulose acetate buryrates, as well as in combination with LCD technologies or glass and optical glasses or other materials that are used in lenses, and all materials that have an optical transmittance and should block UVC, UVB, UVA, blue light and IR. All materials mentioned above can in future, if they are equipped with our technologies, be used to great advantage.

This combined protection against UVC, UVB, UVA, blue light and IR=infrared with the description as in patent claim 1 is currently found neither in windows nor in the glass panes of cars, trucks, visors, aeroplane cockpits, ultra-light or light aeroplanes, window panes of ships, aeroplanes or boats, window facades, windows, doors or other products that have an optical transmittance and should block UVC, UVB, UVA, blue light and IR. Our investigations have shown that modern aeroplanes, such as the types Airbus, Boeing, etc. to name only a few examples, block UV rays up to 390 nm. Other aeroplane types, such as ultra-light aeroplanes, can even be below this value. This results in the following disadvantage, namely that all products and materials that have optical transmittances that can pass UVC, UVB, UVA, blue light and IR can cause strain or damage to the eye in certain strengths and amounts, and for these applications our technology can be used.

According to ophthalmologists, blue light can damage the retina and lead to age-related macular degeneration, AMD. In the infrared range, less is known about eye damage at present. We carefully integrate the IR filter in our patent claim 1. There are indications that IR irradiation in connection with UV irradiation can be carcinogenic. DNA damage

There are many target groups such as paragliders and hang gliders, pilots, different sports, workers and persons who work on the water, in the air or in the outdoors and are exposed to increased levels of UVC, UVB, UVA, blue light and IR radiation, and who daily exceed their own safety levels.

For certain activities where increased outbreaks of sweating are possible, the risk arises that the glasses mist over and the wearer can no longer see anything. This therefore results in an increased risk of accident. We address all possible types of sport, work and leisure activities, as well as products where this protection can be helpful and can improve visibility. In many products, sunglasses, ski goggles, work goggles etc., large ventilation channels are incorporated so that the filters do not mist over. Some even incorporate electric ventilators. This increases the dependence. People who go on skiing trips want something light and independent. A mechanical solution is therefore proposed. There are at present no sunglasses or glasses on the world market with this extension or combinations of the anti-misting system.

We can also apply this anti-misting system for dust safety goggles. Many types of glasses and work goggles cannot be completely closed and immediately begin to mist over. Hence openings are provided for ventilation, which again allow the dust in. That is a real problem that up to now today no manufacturer has solved. We therefore try to keep dust away from the eyes better, that would otherwise place an additional stress on the eye.

Different glass panes, windows that are found in cars, trucks, motorcycles with windscreens, vehicles of all types, ships and boats, aeroplanes, visors, etc., have up to now had no increased UV protection. People are put in danger precisely because the conventional panes or windows let part of the UVA, blue light and infrared through.

The LCD technologies can take on functions that are not currently possible in the same type of product. Phototropic effects that can be carried out in less than a fraction of a second. Filters, windows, and panes of glass must be shaded with roller blinds or other light protection devices. That means that there are no adjustments that can be made that allow a specific LUX value through and therefore give the eye the best desired light level for optimal visibility. The phototropic filters of the current type are counterproductive and a disaster and place an increased load on the eyes! This is the case above all with sunglasses and glasses without side protection. If one drives into a tunnel, the filters or glasses take several seconds before they become lighter. In addition the phototropic effect gradually fades over time.

All persons who are exposed to extreme UV radiations require an additional increased protection for the nose that cannot be given to the same extent by sun creams. Sun creams do not block the UV rays 100%. There are various studies by the WHO that show this. For this reason we have developed a physical sun protection=sun protection for the nose, that can be individually added on and adapted to our glasses system. There are many areas, types of sport and fields of work where the UV rays reach extreme values and a physical means of sun protection is essential. By way of illustration, we name only some examples, such as paragliding and hang-gliding, trekking in the mountains or high mountain regions, surfers, workers etc.

Thus there are disadvantages, for all products, sunglasses, glasses, lenses, windows, window panes and materials etc., that exhibit a light transmittance and allow the UVC, UVB, UVA, blue light and IR through.

Sunglasses that are Adaptable to the Shape of the Face/Anthropometry

The solution exists therefore to combine these different characteristics. The combinations of the properties and technologies can be different according to the field of application. As an example: There is a high probability that an infant or baby requires no enhanced anti-mist system. The side protection and the increased filter protection against UVC, UVB, UVA, blue light and IR can be of great utility in the area of prevention. In the sport, leisure and working domains, where sweating often occurs, it is very important to have both the anti-mist system as well as the extended anti-mist system. The LCD's can make the product more expensive and not everyone requires or wants them. For this reason we are thinking of a system of modules that can be joined together or left out in different combinations. This means that we have a large number of possible combinations and properties that satisfy the needs of our customers, and different new products therefore emerge.

We develop special frames for sunglasses and glasses, which have special joints, fixtures or materials that are flexible. These can be in different fixed sizes, or be moved into different positions with special joints and therefore fit the different face types optimally. This can range from the infant to the adult. The joints can therefore optimally adapt themselves to different head and nose sizes and facial shapes. This can be achieved by means of special constructions of the nose bridge support of FIGS. 1-3. Further fine adjustments can additionally be applied using the nose support (FIG. 7 no. 1). According to the situation, we use larger or smaller nose bridge supports or joint pieces (FIG. 1-3). Either fixed (FIG. 1), or flexible materials (FIG. 2) with or without joints (FIG. 3) can be used. Different variations can have their own areas of application depending on the type of sunglasses or glasses. Flexible or ultra-flexible materials that can even have memory effects are another possibility. Some materials can be reshaped by heating and therefore further adaptations can be made. There are other adjustment possibilities relating to the filter, where we can work with different sizes to optimally adapt to the face type once again in detail. This can occur in face types that have no facial cheeks or cheek bones, or vice versa. We can therefore make optimal adjustments. The reason for this is that 30% of the UV radiation is reflected back in an upward direction in water and even more intensively in snow, up to 80%, and the rays therefore enter the eye through the openings. On the nose support part of FIG. 3, another nose protection device as in FIG. 9 can be additionally and individually mounted and fixed in place. This part then protects the entire nose against the dangerous UV rays. This part can be made of plastic, leather, breathable antibacterial material, photovoltaic cells or from any other desired materials in combination. Additionally we can equip this sun protection part for the nose with solar panels, which then serve as the power supply. We therefore make an advantage out of a disadvantage. Where the irradiation is very intensive, we increase the protection and change the negative area into a positive area, which then delivers a high efficiency and power for the electrical area. There are many areas and types of sport where the UV rays reach extreme values and a physical means of sun protection is essential. One could also imagine the UV index being indicated on the glasses on the LCD display as well. We can mount sensors into the sunglasses, glasses, nose support or externally, and measure the different rays and then transmit this to the LCD screen. (See FIG. 12)

In the case of the protection filter (including all types of lenses), we have managed to develop the combination of UVC, UVB, UVA, blue light and IR, as is seen in patent claim 1. We tested different curves that optimally cover the expanded spectrum UVC, UVB, UVA, blue light and IR while in addition meeting colour recognition requirements in accordance with standards, and are suitable for use in traffic, on ships and for flights. For this, the colours red, yellow, blue and green must be taken into consideration, as well as the transmittance. An important point is that the filter is not too dark. We start from Cat. 2 and Cat. 3, whereby the filters can move from category 2 to category 3. The only concern here is the light transmittance Tv, that is, the visible daylight. We increase or reduce the light transmittance Tv=LUX number. Thus the brightness can be regulated by the phototropic property. Is important that we block the dangerous spectrum of VC, UVB, UVA, blue light and IR. For suitability in traffic, the filters may not fall into category 4. Our goal is not to produce filters that are too dark. If we allow our filter to be bright, and we have integrated the UVC, UVB, UVA, blue light and IR spectrum and then we activate the self-protection, the pupil becomes smaller and protects itself. The curves may change, as we have developed different filter types. All those that are being patented that cover the UVC, UVB, UVA, blue light and infrared ranges, are in accordance with international standards with respect to colour recognition and are suitable for use in traffic, on ships and for flights. The curves, colours and shapes can look different, but the filters must satisfy the characteristics mentioned above. This technology can be used and produced on different materials, such as optically transparent Polymeric Organic Material manufactured from polycarbonates such as poly 4,4-dioxydi-phenyl-2,2-propane sold under the brand name LEXAN, polymethylemthacrylates sold under the brand name Plexiglas, copolymers of polyol arylcarbonates sold under the name CR-39, especially diethyleneglycol bis aryl carbonates polycarbonate, polyester, cellulose propionate, cellulose acetate, acryl carbonates and copolymers, diethylene glycol bis aryl carbonates, vinyl acetates, cellulose propionates, cellulose butyrates, polystyrene and methylemethacrylates, vinyl acetates and acrylonitrile and the copolymers and cellulose acetate buryrates as well as in combination with LCD technologies or glass and optical glasses or products that have an optical transmittance and allow UVC, UVB, UVA, blue light and IR to pass, and it is desired to apply protection to these materials or to new materials.

In addition this increased protection from UVC, UVB, UVA, blue light and IR=infrared could also be integrated into vehicles, such as car windows, truck windows, helmet visors, aeroplane windows and cockpits, windows, window panes as well as window facades, ships, boats and buildings or other possible applications where this protection can be used. We must not forget that our filter technology is suitable for colour, and for use in traffic, on ships and for flights as described in our patent claim 1. Very many other possibilities are therefore available to apply this technology. It therefore results in increased protection and greater safety.

Extendable anti-mist system. Here we have developed a fluid on the fixed anti-mist system, which in combination with the fixed anti-mist coating on the filter allows for extension. Our goal is to enable the use of this anti-mist technology in a sealed pair of sunglasses, glasses, ski goggles, work goggles or other conceivable glasses where UV radiation, blue light, infrared, pollen, fine dust etc. plays an important role, while nevertheless enabling a good closure and providing better vision. Our fluid performs the optimisation of the distribution and therefore prevents droplet development, and also the anti-misting at saturation, which is reached after a few minutes. The filters are applied to a drop in the moist condition and are applied and distributed optimally over the entire filter area. For us, it is very important to point out that we apply and use this means especially for these applications. For the outside of the filters which are exposed to water spray and dirt of all types, our aim is to have a coating and functions, such as the lotus blossom effect. This means that dirt and water spray etc. do not adhere to the filter. (FIG. 6) With this method, we ensure that neither drops of water, dust, grease, oils nor other undesirable deposits or dirt adhere to the sunglasses, glasses or other materials. We can also use these technologies in the interior area of the filter. We introduce a lotus effect on the sunglasses frame, filters or glasses.

LCD technologies. Here we would like to integrate different LCD technologies into our glasses and take advantage of the total knowledge in combination with our sun glasses and glasses. This means that the rationale behind the sunglasses and glasses is based on adaptable nose supports for sunglasses, which can be adapted to many facial shapes/anthropometry, followed by the increased protective filters and the extensible anti-mist system. We incorporate, then, the LCD technologies into our existing technologies. From this we obtain a new, unique top-quality product. The LCD technologies can be assembled in the sandwich method in the form of different levels and in an arbitrary sequence. (FIG. 5) There is also the possibility of constructing everything together in compound methods=mixture methods. These different technologies give us the possibility to further extend the sunglasses, lenses or glasses and to allow completely new functions to be included, which together yield new and useful end materials and products. We will guarantee the supply of power with photovoltaic cells, rechargeable batteries or normal batteries. We try where possible to use and to apply the available natural resources in a positive way.

Using adjustable, flexible, interchangeable nose bridge supports, as well as optimal adaptable filter shapes, which can be additionally applied in different sizes, we can produce and offer sunglasses with optimal side protection (FIGS. 8-10). Supplementary to this is the increase in the protection of the filter due to UVC, UVB, UVA, blue light+IR (FIGS. 4-6). This yields a new dimension in sunglasses or glasses. The nose piece of the frame (FIG. 1-3) is the principal part that allows itself to be optimally adapted to many unique face types and shapes. We are therefore trying to get a better understanding of anthropometry. The nose piece of the frame can be moved rigidly but also flexibly in one direction or in all possible directions (FIG. 1-3 no. 0), or even be fixed if desired. This allows us to adapt better to many asymmetrical head dimensions. These properties that are conceivable in spherical form or with a clip (FIG. 13 no. 26-27), have the advantage that it can also be used for the earpieces of the sunglasses and glasses. Different memory effects on different materials are possible and are used according to the field of application. Which solutions are adopted and yield the best results depends on the construction of the sunglasses and glasses. The different sizes and heights of the nose pieces, which have no restrictions, are selected and used according to the face type. The lenses or filters can have different vertical or horizontal sizes and can be fitted with or without a frame. (FIG. 7, no. 6) This means that better side protection is obtained. The filters follow the facial contours, in the lower and upper area, as well as on the side of the face. We can therefore carry out optimal adaptations. With the nose holder (FIG. 7 No. 1) the fine tunings can be undertaken in addition. On the nose support part, a further adjustable nose protector (FIG. 8 No. 8) can additionally be mounted and adapted individually in different sizes. This part then protects the entire nose against the dangerous UV rays. This part can be made of plastic, leather, breathable material or any desired material, and can even be equipped with photovoltaic cells (FIG. 8 no. 9). The aggressive radiation is thus used positively and is transformed into energy. There are many areas and types of sport where the UV rays reach extreme values and a physical means of sun protection is essential. Examples of these are paragliding and hang-gliding, touring in the mountains or high mountain regions, surfers, workers and all persons that are exposed to UV radiation in very high or extreme conditions. (Recommended: UV index 4 and above). To better hold the sunglasses and glasses in place we recommend

Increased protection filter. FIGS. 4 to 6 show some possible protection curves with UVC, UVB, UVA, blue light and IR=infrared. In our case we are interested in the entire extended spectrum we cover, and nevertheless comply with the EN 1836: CEN, ISO or other standards. These have applications in sunglasses, glasses, lenses; windows, window panes etc. that additionally remain suitable for use in traffic, on ships and for flights. The side protection is also integrated. Optical glasses can be added into our frame, or be solved by LCD technology.

We will implement these protection filters in different possible filter types, filter materials and colours: the possible colours that we will use are unlimited. Here are only a few examples: 1. Colour brown, 2. Colour orange, 3. colour green (FIGS. 4-6), where we can select the colours as desired. The sole issue is the overall and increased protection factor=spectrum, which is not available on the market at present with the properties of suitability for use in traffic, on ships and for flights. In Category 2 in accordance with standards 1836, CEN, ISO or other standards, a light transmittance Tv of 18-43% applies in Category 2, while in Category 3 it is 8-18%. Light transmittance Tv that is less than 8% can be obtained using phototropic properties, and will adversely affect colour recognition and the light transmittance Tv in its entirety, so that the device is no longer suitable for use in traffic, as is described in more detail on page 18. Therefore the light transmittance Tv lies between 8%-43% if it needs to remain suitable for traffic use.

Other areas of application such as vehicle windows of cars, trucks, visors, aeroplane cockpits, window panes of ships and boats, as well as general windows, skylight windows and window facades, doors, glass and plastic glasses etc. along with all materials that allow the transmittance of light as well as UVC, UVB, UVA, blue light and infrared, can be equipped with this technology and offer a higher protection. The darkening of the glass materials can then be carried out by the LCD technology. They can be joined together as a compound, films or other materials to produce new products that require these properties. Also covered by our patent are lenses, contact lenses, disposable lenses that block UVC, UVB, UVA, blue light and infrared. Here is an example of our filter, which should be considered only as a guideline and can vary according to category=. cat. and colour. Tv D65=17.128%, blue light (380-500 nm)=0.739%, spectral transmission (500-650 nm) pass, red signal=pass, yellow signal=pass; blue signal=pass, green signal=pass. Infrared filters are integrated in addition. These filters, lenses, windows, panes and general transparent materials with our technologies are approved for the traffic domain. (FIG. 4-6)

Extendable anti-mist system and non-adhesion of dust and contaminants. For the sport and work fields, we add on the extension of the anti-mist system, which works to prevent water droplets as well as creating an optimal distribution of the emerging moisture and ensuring better visibility. Thanks to these technologies, we can produce very small glasses. This agent can simultaneously act as a cleaning agent, that is also used for the extension of the anti-mist property. Mineral and fat deposits can be rinsed off and removed with running water and this agent. We take a very small drop of this special agent and distribute it uniformly over the clean and moistened filter. This then yields the extendable high-tech anti-mist coating, with integrated and increased protection. For the outside of the filter which is exposed to water spray and dirt, we can apply a coating with the properties of the lotus blossom. Using this method ensures that neither drops of water, dust, fats, oils nor other undesirable deposits stick to the glasses. We can use also use this lotus blossom effect in the interior of the filter, and equip it with the anti-mist coating.

LCD technologies. The LCD solutions make sense when used in sunglasses, glasses, lenses of all types, disposable lenses, windows, panes of glass and materials that allow transmittance of light as well as UVC, UVB, UVA, blue light and infrared, if the above mentioned functions are incorporated. The LCD technologies assist the eye in various situations. As examples, we mention the phototropic properties that can act in fractions of a second. Settings of the filters, glasses or artificial materials that are made lighter or darker (Lux is the SI unit of the derived quantity illuminance. Its unit symbol is lx. 1 lx=1 lm/m²), can be adjusted either manually, automatically or both together. Incident laser radiation, which can enter the eye in a fraction of a second, requires the LCD technology. In addition, individual settings of the glasses lens thicknesses=single dioptres, as well as the possibilities to apply a digital zoom (=enlargement) can be implemented thanks to the LCD. Objects can therefore be made to appear closer. With the LCD technology, we can also obtain a polarisation. New possibilities of the communication and visualisation are available with the LCD technologies, that can be used as an integrated screen, and as a communication, navigation or entertainment platform. With nanotechnologies, we can incorporate this into sunglasses, sports or work goggles, and all conceivable types of glasses with different corrective lenses as well as in glass panes and windows if desired. A further possibility is that the glasses become a communication product, that can perform computer, mobile phone, audio and video functions. We apply these properties again in combination with our protection against UVC, UVB, UVA, blue light and IR=infrared which is clear from patent claim 1, and in vehicle windows such as cars, trucks, visors, aeroplane cockpits, window panes of ships and boats, as well as windows, doors and glasses or plastics, and all materials that allow a light transmittance Tv, and pass UVC, UVB, UVA, blue light and infrared and that observe the values such as are given in patent claim 1. We can fuse these LCD technologies together as a compound; as a granulate or as films in the sandwich method, and joined together with other materials.

The LCD=liquid crystals are offered as new products in the Modular system. The LCD technologies can be integrated into our filters, as well as materials or glasses that have light transmittance. The number of filter units is immaterial, and also the sequence can and must be different. This depends on the desired characteristics. These can be adapted according to the type and the filter in the spectacles. The possibility also exists to use this filter technology in the vacuum area and to assemble them together. For example filter, LCD+vacuum+LCD, filter, wherein the sequence and composition can be constructed differently.

The power supply system of the LCD technologies can be provided by batteries, rechargeable batteries, solar panels or an external power supply. The output power can be different. An intelligent charging procedure can be used, with temperature monitoring and total discharge protection using integrated microprocessors. Further solar modules can be connected in and the entire system is resistant to water spray. In certain areas a USB, Fire-Wire-cable, cigarette lighter or electricity connection is possible in order to guarantee the supply of power. In the nose protector (FIG. 8 no. 9), solar panels can be mounted. It is also possible to install such solar panels on the sunglasses, glasses frame or externally on garments, hats, buildings, vehicles, ships, boats etc.

The device according to the invention effects an increased protection in the eye protection region for many people, animals and plants that exceed their own self protection and that require it. This is determined by genetic make-up as well as the person's increasing age, the intensity of the radiation, the period of time spent outdoors, and the environmental changes such as the shrinking of the ozone layer. As soon as these limits are exceeded, our products come into use. The UV radiation types UVC, UVB, UVA, blue light and IR can be dangerous in an increased or excessive dose. With a further reduction in the ozone layer, our eyes require an increased protection, which we can offer with our filters. The sunglasses, glasses and lenses are not only fashionable accessories, but they must assume and fulfil important functions and characteristics, which are proven through years of research and which can be of great advantage to the user in the prevention of harm. It is well known from many years of experience how important the area of sun protection is. In eye diseases, such as cataracts, AMD=Age-related Macular Degeneration etc., with the prevention and the correct products we can reduce the risk curve of the disease. There are various scientific and representative studies of AMD as well as possible causes, and blue light is one of the causes of AMD. These different characteristics, with different combinations of technologies that are found in our products, can be used in the outdoor arena to provide increased protection. The whole idea only has a useful purpose and advantage if we take into account facial shapes and optimally tune the entire system to the filters. The glasses lenses or filters can have different vertical or horizontal sizes and lengths and can be fitted with or without a frame. (FIG. 9 no. 10) The advantage is that we can consider and implement different customer wishes with or without frames. The entire system in this unique combination, with the adjustable side protection, our unique filtering (UVC, UVB, UVA, blue light and infrared), which are then also colour-capable, qualified for traffic, ship and flight, forms a new dimension of products. With these new characteristics and products, more than 10 years of research, development and experience have gone into these sunglasses, glasses, all types of lenses, contact lenses, disposable lenses, as well as window panes, windows and other products, that have a light transmittance Tv or transmit one of these radiation types such as UVC, UVB, UVA, blue light and IR=infrared, and which require additional protection.

In addition to this, as illustrated in FIG. 12, an intelligent sweat barrier and light stopper, and shock absorbers (FIG. 12, no. 14+16) are provided for the sunglasses and glasses, which use a controlled air diaphragm or special materials to cushion the pressure that occurs on the impact of an object, reduce it and distribute the remainder in such a way that the pressure decreases by a large factor. Taking the example of air, when the counter-pressure occurs it fills up again by sucking in air and is therefore ready for the next impact. The same process could work in combination with air, water or other materials. Further variants include special elastic molecular materials with special structures, which are soft and harden immediately on impact and dissipate and distribute the pressure in an optimal way by means of specific structures. Combinations of the methods are also conceivable. There are advantages in the work arena, for infants, sporting activities such as for example soccer, volleyball or in PE instruction in schools or kindergarten where children play outdoors. This increased shock protection of the head and the eyes has the advantage that in fields of application where no sunglasses or glasses are currently worn, this will be more easily possible in future and therefore be increasingly used. These functional parts acting as sweat barriers, light stoppers and shock absorbers can also be built into the entire pair of sunglasses or glasses.

On the nose support part FIG. 1-3, another nose protector can additionally be individually mounted and fixed in place. This part protects the entire nose against the dangerous UV-rays UVC, UVB, UVA, blue light and infrared. This nose part can be manufactured from plastic, leather, breathable antibacterial material or from any other desired materials and in different combinations. The outer part of the nose piece can be covered or coated with solar cells and thus serves not only as protection but also as an energy producer and supplier. This current can be stored in rechargeable batteries, which are in turn used positively for LCD technology. There are many types of sports, fields of work and other areas where the UV rays reach extreme values and physical protection from the sun is of great advantage. As examples, we cite paragliding and hang-gliding, trekking and touring in the mountains or high mountain regions, surfers; workers, kiting, etc. By means of these new technologies and combinations of the individual parts, we obtain products that offer higher protection over a person's lifespan from infancy to adulthood. Thanks to a modular system you can extend the sunglasses, glasses or other products according to your needs. In addition to this is the fact that many people are ageing and in the approach to preventive treatment we must improve the distribution of the dangerous UVC, UVB, UVA, blue light and infrared radiation over our lifespan. Due to the reduction in the ozone layer, the intensity of the radiation is also increasing. Such high-tech filters can thus make an important contribution in old age and increase the quality of life. In treating AMD, ophthalmologists today find it difficult to offer a satisfactory solution to patients suffering from Age Related Macular Degeneration (AMD). We can therefore make a positive contribution to preventive treatment, and reduce the percentage of eye damage by the use and combination of these protective measures and properties. There are also many types of occupation that are carried out in extreme locations and urgently require such protection. Based on scientific data and experiments, we are well aware that many people affected daily exceed their safety limits in the summer and pay a price for this with their future health in old age, in the form of eye diseases and skin diseases.

The anti-mist system and the extension of the anti-mist system gives us the possibility of making our sunglasses and glasses very small. They therefore become lighter and more compact. We also achieve a very good seal, something that other sunglasses and glasses today do not, because with the same construction they mist over within a few seconds or minutes. As an example, we mention modern ski goggles, which have very large ventilation channels at the top and bottom. This is very important for ventilation. Everywhere where the UV rays are very intense and the UV index reaches extreme levels, such sunglasses and glasses as we design provide real prevention and relief for the eyes. We can also use this technology for areas high in dust and pollen, and industrial areas. This sealing relieves the eyes from unpleasant as well as dangerous intrusive agents and helps in preventive treatment. The product is applied on the filter as a cleaning agent and at the same time as an anti-mist system.

For the outside of the filter where water spray, oils, grease, dust and pollution of all types occur, a coating of superhydrophobe polymer surface nanotechnology with surface structuring, with lotus blossom properties, is applied permanently on the filter. This results in the advantage that no drops of water, dust, grease, oils or other undesirable deposits and contaminants collect on or adhere to the sunglasses, filters, glasses, lenses, glasses, or windows. All products are therefore self-cleaning. The entire system could also be used on the inside and therefore eliminate sweat residues, mineral salt deposits, grease, dust, sun-cream deposits or other undesirable contaminants. In sports or certain areas of work, we can use this product in an optimal way. Here also, our goal is the combination of the characteristics mentioned. This in its entirety gives rise to new products that are not available in this form today.

Increased eye protection is characterised by the fact that a side protection of a pair of sunglasses or glasses, FIG. 10, extends all around the eyes and the face, and by different adjustable nose base pieces (FIGS. 1,2,3+7), either fixed (FIG. 1), with memory effect (FIG. 2) or flexible (FIG. 3), and adaptable filters (FIG. 7 no. 6) are provided according to facial shape=anthropometry, and are adjustable. The nose base pieces are characterised in that they have different sizes and shapes. They are additionally characterised by spherical shapes that are secured in the frame or on the nose base pieces (FIG. 1 or FIG. 3), and can be moved in different directions. Certain spheres are characterised in that in addition they can have certain lattice shapes on the sphere, where the counterpart=counter shape goes into the sphere and can have raised areas, dimples or other desired characteristics and shapes. This means that different positions can be set and fixed as desired. Other attachment possibilities are characterised in that hinges, barbed hooks (FIG. 13 no. 26+27), pivot screws, springs, screws, or a combination of these, can be used. The nose base piece is additionally characterised (FIG. 3 no. 20-23) that it can incorporate electronics, batteries, rechargeable batteries, solar cells and different sensors such as UV, blue light, IR, MP3, MP4 in modular format or in different combinations.

Increased eye protection of the filters of FIGS. 4-6 is characterised by an expanded spectrum of UVC, UVB, UVA, blue light and infrared, and are suitable for colour recognition and use in traffic, on ships and for flights. Suitable for use in traffic, on ships and for flights is defined such that recognition of colours such as red, yellow, blue and green is considered and therefore meets traffic suitability and the light transmittance Tv; this is evident over the entire spectral curve, as shown in FIG. 4,5.6; the light transmittance Tv can vary from 8% to 43% which is described accurately in accordance with patent claim 1. FIGS. 4-6. This covers all conceivable colours that have the same properties under the claimed protection. Filters can range from Category 2 phototropic to Category 3 and can have the properties named above. There is therefore no colour restriction for the filter manufacture. Any desired colours can be produced. The filters for suitability in traffic must not come into Category 4, and as anti-glare protection they should still allow a light transmittance Tv of between 8%-43%. Our aim is not to produce filters that are too dark. Our filters are characterised in that they are light in Category 0-3, and have integrated the UVC, UVB, UVA, blue light and IR spectrum and the built-in protection mechanism which activates the reduction of the pupils. The curves are intentionally not defined and must be different, but they do cover the UVC, UVB, UVA, blue light and infrared range and can vary within categories 0-3. If they should fall into category 4, they would no longer be suitable for use in traffic, on ships or flights in accordance with standards.

Increased eye protection can therefore be applied to further products, that allow a light transmittance Tv as well as passing UVC, UVB, UVA, blue light and infrared. Further products are characterised in this way, such as all types of lenses, including disposable lenses and contact lenses, objective lenses, lenses for objectives, corrective glasses with dioptre values, all conceivable materials that are in the optical range, all types of spectacles, swimming glasses, telescopes, ski goggles, sports goggles, leisure glasses, work goggles as well as types of sunglasses, that are used in different areas and exhibit the same or similar properties.

Further products for eye protection are characterised in that they are made of materials that are used in application areas such as vehicle window panes of cars, trucks, motor cycles, aeroplane cockpits and window panes, cranes, window panes of ships and boats, visors, as well as windows, window facades, doors, general glass and artificial glasses, as well as all materials that allow light transmittance and transmit UVC, UVB, UVA, blue light and infrared, and require the same protection and are suitable for colour recognition and use in traffic, on ships and for flights. These materials are characterised by this and give rise to the claim that they can be joined together as a compound, films=different layers or other materials, and yield various new products.

Other materials that can be produced and used with these technologies are characterized in that they are manufactured using optically transparent Polymeric Organic materials, from polycarbonates such as poly 4,4-dioxydi-phenyl-2,2-propane sold under the brand name LEXAN, polymethylemthacrylates sold under the brand name Plexiglas, copolymers of polyol arylcarbonates sold under the name CR-39, especially diethyleneglycol to aly carbonate, polycarbonate, polyester, cellulose propionate, cellulose acetate, acryl carbonate and copolymers, diethylene glycol to aryl carbonates, vinyl acetates, cellulose propionate, cellulose butyrate, polystyrene and methylemethacrylate, vinyl acetate and acrylonitrile and the copolymers and cellulose acetate buryrate, as well as in combination with LCD technologies or glass and optical glasses or materials, that have an optical transmittance and transmit UVC, UVB, UVA, blue light and IR, and need to be made with our filter technology and be suitable for colour recognition and use in traffic, on ships and for flights.

In the case of greater penetration of light on the upper forehead incident side of the sunglasses or glasses where increased eye protection=side protection is necessary, it is characterised by intelligent additional forehead protection parts, that are possible in different combinations, in the form of sweat or light barriers and shock absorbers (FIG. 12, no. 14+16) for the sunglasses and glasses. The additional forehead protection part is characterised in that a controlled air diaphragm or special materials are used to cushion the pressure that occurs on the impact of an object, reduce it and distribute the remainder of the pressure in such a way that it cannot act at particular points. After this occurrence, the membrane or container fills up again with air or fluid (sea, lake, river etc.). This membrane is characterised in that it even allows only air in and does not let any fluid or moisture in. In addition the diaphragms are conceivable with different air chamber volumes. It is characterised in that it can be optimally adapted according to the type of sport and eyelash length. Therefore the forehead protection part is ready again for the next impact. Further claims are characterised in that different variants of the sweat barrier, light barrier and shock absorber are equipped with special elastic molecular materials that cushion the pressure with special structures that are soft and immediately harden on impact, and that optimally dissipate the pressure through specific structures and better distribute it so that it is not applied at particular points. A further claim consists in the fact that the materials used are characterised by being breathable, antibacterial, water resistant and that they can be built up from in several different layers.

These sweat barriers and light stoppers and shock absorbers of FIG. 12 no. 16-14 are characterised in that they can also be equipped with electronics and transmit, exchange and receive the contact and information to and from the sunglasses and glasses.

Thus, any desired functions can be put into operation. There is also the possibility of the intelligence that is characterised in that it is to be incorporated in the various frames or secured as an additional fitting on the glasses or fixed externally on the sunglasses, glasses or other materials. A further claim arises and is characterised in that the sunglasses and glasses are equipped with a receiver, and the transmitter(s) do not necessarily have to be mounted on the glasses but can be mounted externally. A further claim arises that the sweat barrier, light barrier and shock absorber are characterised in that they can be fixed on the frame. The electronics will in addition be characterised in that it is integrated in layer form and can be compliant with IPS 44 to IP 67. The electronics is therefore better protected against water and moisture.

Due to the better closure, the problem of the misting over of the filter can increase. To deal with this a special anti-mist coating has been created, that is additionally extendable. It is characterised in that it is additionally applied and distributed optimally on the filter in the wet state with a droplet on the filter surface, which already has a fixed anti-mist coating. The claim consists in that this liquid is characterised in that it performs the optimal distribution and drop development on the filter, as well as a formation of a white coating, that could lead to the reduction of visibility or even prevent it. In addition it is characterised in that the quickly drying formula of the liquid can dry the sweat on the filter better and more quickly. Thanks to these properties, the device according to the invention has the property that much smaller and ultra-light sunglasses and glasses can be produced, which provide a better seal against dust, wind, pollen, smoke and other conceivable unpleasant particles, as well as dirt particles that can enter the eyes and adversely affect them.

Owing to the better closure, mineral salts, grease deposits, sun creams, oils and other unpleasant contaminants can adhere to the filters. Also in the outside part of the filter, this can be even more acute. Embodiments are characterised in that for the outside of the filter where water spray, oils, grease, dust and contaminants of all types arrive, a coating of superhydrophobe polymer surfaces nanotechnology with surface structuring, with lotus blossom properties, is applied permanently on the filter. This yields the advantage that no drops of water, dust, grease, oils or other undesirable deposits and contaminants collect on or adhere to the sunglasses, filters, spectacles, lenses, glasses, windows, panes etc. A further claim consists in the fact that all products are characterised in that they are self-cleaning. The entire system is therefore characterised in that it can also be used on the inside and can therefore result in an end to sweat residues, mineral salt deposits, grease, dust, sun-cream deposits or other undesirable contaminants. This characteristic is therefore characterised in that it is used everywhere where sweating and working occur and dirt is present. A further claim is thus characterised in that different combinations are possible inside and outside, with the characteristics mentioned. In its entirety this gives rise to new products that are not available in this form today.

LCD technologies are characterised in that they are used in combinations with sunglasses, spectacles, windows, panes, corrective glasses, lenses, contact lenses and disposable lenses, glass, optical glasses or other materials that allow light transmittance and in which increased protection is desired, such as from UVC, UVB, UVA, blue light with or without infrared radiation, and they can lead to products. The claim is made for refinement, and therefore obtaining new products and offering further added value. The claims consist in phototropic properties that that can be driven in less than a fraction of a second by a LUX sensor to become lighter or darker, displays for the communication of all visual data, laser protection in less than fractions of a second, continuous individual dioptre adaptation of the filters and glasses as well as colour settings and polarisation possibilities which that can be switched on or turned off. Also conceivable is a digital enlargement when viewing or using a telescope and this could be adjustable via an internal or external electronics.

The supply of energy is characterised in that it can be delivered via batteries, accumulator batteries that are also rechargeable (FIG. 12 no. 15 or FIG. 3 no. 25), or by an internal or external energy supply, that can be supplied directly or externally via solar panels. An intelligent charging procedure can be used, with temperature monitoring and total discharge protection using integrated microprocessors. Further claims are characterised in that solar modules can be connected and the entire IP 44 to IPS 67 is protected. Because we use electricity, it is important to construct the housing so that it is protected internally in accordance with IP=International Protection against dust, moisture, water spray or water. The types of protection are designated by internationally valid codes (IP=International Protection). The abbreviation IP is followed by two digits. The first digit stands for the protection against the intrusion of solid bodies. The second digit describes the protection level against the penetration of water. Further claims are characterised in that a USB, Fire-Wire cable, cigarette lighter or electricity connection is possible in certain areas, in order to guarantee the supply of power.

The nose protector in accordance with FIG. 8 no. 9 is characterised in that solar panels can be additionally installed. Further claims exist and are characterised in that such solar panels are also to be installed on the sunglasses, spectacle frames or externally on garments, hats, buildings, vehicles, aeroplanes, ships, boats etc. Intelligent controls ensure that sensors can also measure the UV radiations, blue light and IR and display them on LCD displays.

Further embodiments are characterised in that sensors can also be fixed externally on the sunglasses, glasses or on other materials. The computer calculates, processes and then transmits the data to the LCD displays. Using the Lux value detector, the optimal light intensity for the eyes is individually adjusted. The Lux values (lx. 1 lx=1 lm/m²), will be able to be manually or automatically adjusted. Further embodiments are characterised in that incident laser irradiation, that can enter into the eye in a fraction of a second, can be stopped by the LCD technology in fractions of a second and cannot reach the eyes.

Further embodiments are characterised in that, in addition, thanks to LCD technology individual settings of the spectacle lens strengths=individual dioptres, plus the option to provide a digital zoom are obtained. Objects can be made to appear closer as desired.

Further embodiments are characterised in that the LCD technology allows a polarisation of the filters to be obtained, that can be turned on or off as desired.

Further embodiments are characterised in that new possibilities of communication and display exist with the LCD technologies that are integrated as a screen and can be used as a communication, navigation or entertainment platform. This can be incorporated with nanotechnologies into the sunglasses, sports and working goggles, or all conceivable types of glasses with different corrective lenses, and panes and windows if desired.

Further embodiments are characterised in that there is a further possibility that glasses or sunglasses become a communication product, that can perform computer, mobile phone, audio and video functions in a modular or integral fashion.

Further embodiments are characterised in that LCD technologies are fused together as a unit=granulate or in the form of films in arbitrary sandwich methods, and can be joined together with other materials.

Further embodiments are characterised in that LCD technologies can be offered in modular form as new products.

Further embodiments are characterised in that the number of filter units is immaterial, and also the sequence can be constructed in a modular fashion and in different ways. This depends on the desired characteristics and requirements.

Further embodiments are characterised in that the possibility also exists of using the filters and filter technology in the vacuum zone and of constructing them together. Example: filter, LCD+vacuum+LCD, filter. Wherein the sequence and composition can be constructed in a modular fashion and in different ways.

Further embodiments for fine tuning are shown in FIG. 7 no. 1, in addition to which the nose support placed on top of it is a secondary feature. A further embodiment shows the nose pad with very highly adherent bionic technology, that can be equipped with small and comfortable suction cups.

Further embodiments relate to the arm frames of the glasses in the area of the ear, which are flexible in all directions and adjustable and adaptable, and can also be equipped with the same very highly adherent bionic technology with fine suction cups if necessary and desirable.

1. Device with at least one filter, in particular for a relieving and preventive eye protection as glasses, sun glasses or pane, wherein the device comprises at least one filter for influencing and filtering UV, blue light and infrared radiation, wherein the at least one filter is characterized by specific limit values defined in their combination, wherein the at least one filter filters, in combination, the transmission of INC, UVB, UVA, blue light and infrared radiation, is qualified for traffic, ship and flight according to norm EN 1836, and has total spectral characteristics with corresponding light transmission degree Tv and the following, in combination characteristically fulfilled filter properties defined according to the norm EN 1836:
UVC, UVB, UVA spectrum is completely filtered the light transmission degree Tv ranges from 8% to 43%;
a special blue light protection filter for blue light radiation additionally acts for further relieve of the eyes and filters the blue light spectrum from 380 nm to 500 nm either up to 98.2% or up to 99.6% or even up to over 99.6%;
a special infrared protection filter which filters the infrared radiation over the whole infrared range acts with an non-weighted average value of under 30% of the passing infrared radiation, which corresponds to an average value of under 25% of the infrared radiation as computed by infrared weighting according to norm EN 1836, with an average value from 7% of the passing infrared radiation up to 0%.

2. Device according to claim 1, characterized in that the at least one filter is chosen such that the device fulfills the norm EN 1836 as well as CEN and ISO norms and lies in the category 0 to 3 according to norm EN 1836, wherein the limit values defined in their combination surpass said norms with respect to protection range.

3. Device according to any of the preceding claims, characterized in that the device forms an element from a group comprising:
lenses, in particular day and contact lenses, objectives, lenses for objectives, correction glasses, optical materials, telescopes and glasses, in particular swimming goggles, ski goggles, leisure time glasses, work time glasses and sun glasses of all kinds.

4. Device according to claim 1, characterized in that the device is formed as a pane, in particular as a front shield of cars, trucks, motor bicycles, plane cockpits, cranes, ships and boats, or as an eyepiece, window, window faQade or door.

5. Device according to claim 4, characterized in that the device consists of a compound (composite) or is coated with a foil.

6. Device according to claim 1, characterized in that the at least one filter consists of materials selected from a group consisting of:
optical transparent polymeric organic materials, polycarbonates such as poly 4,4-dioxydi-phenyl-2,2-propane, polymethylemthacrylates, copolymers of polyol arylcarbonates, especially diethyleneglycol bis aly carbonates polycarbonate, polyester, cellulose propionate, cellulose acetate, acryl carbonates and copolymers, diethylene glycol bis aryl carbonates, vinyl acetates, cellulose propionates, cellulose butyrates, polystyrenes and methylemethacrylates, vinyl acetates and acrylonitriles and copolymeres and cellulose acetateburyrates.

7. Device according to claim 1, comprising a controllable arrangement based on LCD technologies which changes optical properties of the at least one filter, in particular light transmission degree, phototropic properties, diopter adjustments, color settings, polarization or digital enlargement.

8. Device according to claim 7, comprising an illuminance sensor/LUX sensor for measuring the illuminance, and comprising a control device for the arrangement based on LCD technologies, controlling the arrangement in such a way that the transmission of the arrangement changes in dependence of the illuminance and adjusts to the eye.

9. Device according to claim 8, characterized in that the illuminance sensor and the control device are arranged such that the transmission is changeable in less than 1 second.

10. Device according to claim 7, characterized in that sensors are arranged for measuring the UV radiation and/or the blue light and/or the IR radiation, wherein the measurement values can be displayed, in particular, via an LCD display.

11. Device according to claim 1, characterized in that the device comprises sensors, a computer, and an LCD display, wherein the computer generates data for the LCD display based on the sensor values measured by the sensors.

12. Device according to claim 11, characterized in that one of the sensors is a light sensor or LUX detector detecting the light intensity, and the LCD display is controllable in such a way that individual light intensity corresponding to each person can be adjusted individually for the eyes, in particular manually or automatically.

13. Device according to claim 12, characterized in that the arrangement based on LCD technologies is adapted to react so fast that incoming laser radiation, which can reach the eye in a fraction of a second, is stopped by the LCD technology in split seconds and cannot reach the eyes.

14. Device according to claim 13, characterized in that the arrangement based on LCD technology is arranged such that a polarization of the at least one filter is possible, which can, in particular according to desire, be switched on or off.

15. Device according to claim 14, characterized in that the arrangement based on LCD technology, as compound (composite), is melted together from granulate or is arranged as foils in a sandwich method.

16. Device according to claim 1, in the form of sun glasses, comprising a side protection and an adjustable nose base piece for adjustment to different facial forms.

17. Device according to claim 16, characterized in that the nose base piece comprises holding means into which ball shaped parts of the glasses frame are insertable such that the frame is movable which respect to the nose base piece in different directions by means of the ball shaped parts, and can thus be adjusted to the size of the head.

18. Device according to claim 17, characterized in that the ball shaped parts can have structures on their surfaces, which can have a raster form or burling form, and that the nose base piece is formed as a counter piece/counter form, to which the ball shaped parts adhere, wherein the counter piece can have burling, bulgings or other forms such that the mutual position of the frame and the nose base piece is adjustable and fixable.

19. Device according to claim 1, in the form of glasses, characterized in that the glasses have alinasal parts or earpieces, the materials of which have special suction properties, arranged with bionic technology like that of gecko feet, wherein, by the fineness of single adhesion hairs in the nano scale or by acetabula as with frogs, the adhesion force can be adjusted individually.

20. Device according to claim 19, characterized in that an arm piece of the glasses in the area of the ears is flexibly adaptable and adjustable in all directions, and, in particular, is arranged with the same bionic technology with acetabula.

21. Device according to claim 1, characterized by filters with special filter colors with bright/dark scaling and phototropic effect.

22. Device according to claim 1, characterized by filters with special filter colors and filter properties which are manufacturable as a mixture or in layers.

23. A filter for eye protection, having the following properties according to the norm EN 1836 and the quantities and measurement specifications defined therein:
a) the filter is qualified for traffic;
b) the filter filters the UVC, UVB, and UVA spectrum to 100%;
c) the light transmission degree Tv of the filter ranges between 8% to 43%;
d) the filter filters the blue light spectrum from 380 nm to 500 nm to at least 98.2%, typically to at least 99.6%;
e) the filter filters infrared radiation such that, with respect to a non-weighted average value, less than 30% of the infrared radiation pass, which corresponds to a weighted average value of less than 25%.
